(19) United States
(12) Patent Application Publication
(10) Pub. No.: US 2003/0085856 A1
(43) Pub. Date: May 8, 2003

(54) System and method for minimizing image degradation in LCD microdisplays

(76) Inventors: Terence R. Klein, Averill Park, NY (US); Jerome A. Frazee, Milpitas, CA (US); Russell J. Flack, Scottsdale, AZ (US); John Karl Waterman, Mesa, AZ (US)

Correspondence Address: Paul R. Morico, Baker Botts L.L.P., One Shell Plaza, 910 Louisiana Street, Houston, TX, 77002-4995, US

(21) Appl. No.: 10/004,518

(22) Filed: Nov. 2, 2001

(51) Int. Cl. G09G 3/36

(52) U.S. Cl. 345/87

(57) ABSTRACT

A system and method for writing a video frame row by row in a liquid crystal display (LCD) having a matrix of liquid crystal pixels arranged in a plurality of columns and a plurality of rows is provided. The system and method are constructed and arranged to minimize image degradation in the LCD by charging the column capacitors to a mid gray voltage or some other common fixed voltage prior to writing each row. The fixed charge voltage may be achieved by coupling all of the column capacitors together and allowing them to equalize to an average voltage before each row is written. In a preferred embodiment, a successive column or group of columns is charged to the mid gray voltage while the preceding column is being charged to the desired video voltage and that sequence is repeated until each pixel in each row is written.

### FIELD OF THE INVENTION

The present invention relates generally to liquid crystal display devices, and more particularly to a system and method for minimizing the image degradation that often occurs during the writing of a frame of video information to a liquid crystal display comprising a plurality of pixels.

### BACKGROUND OF THE INVENTION TECHNOLOGY

Liquid crystal displays (LCDs) are commonly used in devices such as portable televisions, portable computers, control displays, and cellular phones to display information to a user. LCDs act in effect as a light valve, i.e., they allow transmission of light in one state, block the transmission of light in a second state, and some include several intermediate stages for partial transmission. When used as a high resolution information display, as in one application of the present invention, LCDs are typically arranged in a matrix configuration with independently controlled pixels (the smallest segment of the display). Each individual pixel is signaled to selectively transmit or block light from a backlight (transmission mode), from a reflector (reflective mode), or from a combination of the two (transflective mode).

LCDs are actuated pixel-by-pixel, either one at a time or a plurality simultaneously. A voltage is applied to each pixel and the liquid crystal responds to the voltage by transmitting a corresponding amount of light. In some LCDs an increase in the actuation voltage decreases transmission, while in others it increases transmission. When multiple colors are involved for each pixel, multiple voltages are applied to the pixel at different positions or times depending upon the LCD. Each voltage controls the transmission of a particular color. For example, one pixel can be actuated to allow only blue light to be transmitted while another allows only green. A greater number of different light levels available for each color results in a much greater number of possible combination colors.

Converting a complex digital signal that represents an image or video into voltages to be applied to the pixels of an LCD involves circuitry that can limit the monochrome resolution. The signals necessary to drive a single color of an LCD are both digital and analog. It is digital in that each pixel requires a separate selection signal, but it is analog in that an actual voltage is applied to the pixel to determine light transmission.

Each pixel in the core array of the LCD is addressed by both a column (vertical) driver and a row (horizontal) driver. The column driver turns on an analog switch that connects an analog voltage representative of the video input (control voltage necessary for the desired liquid crystal twist) to the column, and the row driver turns on a second analog switch that connects the column to the desired pixel.

The video inputs to the LCD are analog signals balanced around a center reference voltage of typically from about 6.0 to 8.0 volts. A common reference voltage is not a supply or signal from anywhere, rather it is a mathematical entity. Nearly the same as the center reference voltage is a voltage called “VCOM,” which connects to the LCD cover glass electrode, which is a transparent conductive coating on the inside face (liquid crystal side) of the cover glass. This transparent conductive coating is typically Indium Tin Oxide (ITO).

One frame of video pixels are run at voltages above the center reference voltage (positive inversion) and for the next frame the video pixels are run at voltages below the center reference voltage (negative inversion). Alternating between positive and negative inversions results in a zero net DC bias at each pixel.

In the gray area of the LCD response curve, very small errors in voltage cause unacceptable artifacts in the viewed image. Due to the frame rates that the displays run at it is necessary to load the analog voltages very quickly. As such, the sample and hold function that determines the pixel's voltage is very sensitive. When a pixel is written, the sample and hold function must apply the incoming video voltage to the column capacitor and the associated pixel capacitor. This is done by closing the column switch and pixel switches in an appropriate fashion. The time constant of the column capacitor dominates the function and the charging of the pixel capacitor can be ignored for practical purposes. Due to the nature of the function, when a row has been written the column capacitors are left with an image of the voltages associated with the previous row. Thus, when a row is being written the voltage on the column capacitor is typically being changed from the voltage associated with the previous row to the new voltage associated with the current row.

The problem arises when the previous row had differing voltages from the row being written. The worst case occurs when the previous row has areas of white and areas of black and the next row to be written is a uniform gray. Since the pixels are essentially and RC circuit settling out to an end value, the end value will be slightly different if the initial values are different. This error in voltage results in unacceptable image degradation.

The problem is manifested in the display in several fashions. Typically, it is seen as a darker gray area when a black area is displayed in a uniform gray field. The darker gray area is found in the next row to be written after the black area ends. Depending on the exact system and method used to write the display, there are two locations where the darker gray area appears. In one location, the darker gray area appears one row below the black area and aligned with the black area. In the other location, the darker gray area appears one row below the black area and one column off from the black area.

One solution to the problem would be to slow down the frame rate that the display runs at. The drawback of this solution is that the frame rates at which the display would have to run to cause a visible improvement are too low, that is, under 120 hertz. Typical RGB applications require that the display be refreshed at 120 hertz or higher to have acceptable display of video images. Sequential color applications require frame rates in the 300 hertz or higher range.

Another solution is to reduce the column capacitance. However, the column capacitance can be reduced only so much because of the constraints placed by the construction of the silicon chip on which the display is formed. One such constraint is that the column metallizations run across the entire chip with each one being roughly X femtoFarad of capacitance. Also, there is considerable capacitance due to the hundreds of disconnected column traces. The capacitance of each disconnected switch is roughly Y femtoFarads. For example, in an SXGA microdisplay driven with four channels, each video line is attached to 1280/4=320 solid-state switches. Usually, only one or two of the switches is turned on at any time, leaving the capacitance of 319 or 318 disconnected switches attached to the video line.

Yet another solution is to reduce the resistance of the drive circuit. However, the semiconductor process, size and speed considerations limit reductions in the resistance. Much of the resistance is due to the very long column metallization surface. A typical column trace is U microns wide by V millimeters long. The trace is deposited aluminum with a typical resistance value is W ohms. Another contributor to the resistance is the column solid-state switch. Such switches are limited to widths on the order of the pixel sizes, which are typically around 10 microns. The “On” resistance of such switches are typically V ohms.

### SUMMARY OF THE INVENTION

The present invention overcomes the above-identified problems as well as other shortcomings and deficiencies of existing technologies by providing a system and method for precharging the column capacitors to a fixed voltage prior to writing each row.

In one embodiment, the liquid crystal display (LCD) has a matrix of liquid crystal pixels arranged in a plurality of columns and a plurality of rows. The plurality of columns have an associated plurality of column switches, which are adapted for coupling the columns of the LCD to an output voltage. The plurality of rows have an associated plurality of row switches, which are adapted for selectively coupling the plurality of columns to the pixels of the LCD. The LCD includes logic circuitry, which is coupled to the plurality of column switches and the plurality of row switches. The logic circuitry is adapted to send a control signal to the plurality of column switches to couple the plurality of columns to a fixed voltage prior to the writing of each row, thereby precharging the column capacitors prior to the writing of each row.

In one aspect of this embodiment of the present invention, the logic circuitry is coupled to at least one digital-to-analog converter (DAC), which outputs the output voltage. The logic circuitry commands the at least one DAC to output a desired video voltage. In another aspect of this embodiment of the present invention, the logic circuitry commands the at least one DAC to output the fixed voltage.

In another embodiment of the present invention, the LCD includes a plurality of secondary column switches adapted for coupling at least one of the plurality of columns to a fixed voltage. In this embodiment, the logic circuitry is coupled to the plurality of primary and secondary column switches and the plurality of row switches, and is adapted to send a control signal to the at least one secondary column switch to couple at least one of the plurality of columns to the fixed voltage thereby precharging the at least one column prior to the writing of each row.

In yet another embodiment of the present invention, the logic circuitry is adapted to send a control signal to the plurality of column switches to couple the plurality of columns to each other to thereby equalize the one or more voltages stored on the columns prior to the writing of each row.

In still another embodiment of the present invention, the logic circuitry is adapted to send a control signal to one primary column switch to couple its associated column to a desired video voltage. It also sends another control signal to a secondary column switch in a successive column so as to couple the successive column to a fixed voltage. This arrangement thereby enables the successive column to be precharged to the fixed voltage, which is preferably a mid gray voltage, while the preceding column is being charged to the desired video voltage. The logic circuitry is further adapted to send a control signal to the primary column switch to couple the successive column to a desired video voltage and send a control signal to a secondary column switch corresponding to the next successive column to couple the next successive column to the fixed voltage. This enables the successive column to be charged to its desired video voltage as the next successive column is being charged to the fixed voltage. This sequence of charging one column capacitor to a desired video voltage while the successive column capacitor is being charged to the fixed voltage is repeated until all of the pixels in a given row have been written. It is then repeated for each successive row until all of the rows in the matrix have been written.

In one variant of this latter embodiment, the logic circuitry is adapted to send a control signal to the secondary column switches in a group of columns, i.e., the successive two or more columns, to couple the group of columns to the fixed voltage while the preceding column is being charged to the desired video voltage.

In yet another embodiment of the present invention, a method for writing a video frame row by row in a liquid crystal display (LCD) having a matrix of liquid crystal pixels arranged in a plurality of columns and a plurality of rows, wherein each column has an associated capacitor and each pixel has an associated capacitor is provided. The method includes the step of charging the column capacitors to a fixed voltage prior to writing each row. In one aspect of this embodiment of the present invention, the column capacitors are charged to a fixed voltage by coupling them to an analog voltage driven to a mid gray voltage under the command of a logic circuit. In another aspect of this embodiment of the present invention, the column capacitors are charged to a fixed voltage by coupling them to a voltage supply driven to a mid gray voltage.

In another embodiment of the present invention, the method is carried out by coupling the column capacitors together after a row has been written and prior to writing the next row, so that the voltage stored on the column capacitors during the writing of the previous row is equalized to an average value prior to writing the next row.

In still another embodiment of the present invention, the method is carried out by charging a column capacitor to a desired video voltage while charging a successive column capacitor to a fixed voltage during the writing of each row. In this embodiment, after the successive column capacitor is charged to the fixed voltage it is charged to a desired video voltage and at the same time the next successive column capacitor is charged to the fixed voltage. The sequence of charging one column capacitor to a desired video voltage while the successive column capacitor is being charged to a fixed voltage is repeated until all of the pixels in a given row have been written. The sequence is then repeated for each successive row until all of the rows in the matrix have been written.

A variant of the latter method is performed by charging a group of successive column capacitors, i.e., two or more successive column capacitors to a fixed voltage while charging the column capacitor to the desired video voltage.

Other technical advantages of the present disclosure will be readily apparent to one skilled in the art from the following figures, descriptions, and claims. Various embodiments of the invention obtain only a subset of the advantages set forth. No one advantage is critical to the invention.

### BRIEF DESCRIPTION OF THE DRAWINGS

A more complete understanding of the present disclosure and advantages thereof may be acquired by referring to the following description taken in conjunction with the accompanying drawings, in which like reference numbers indicate like features, and wherein:

FIG. 1 is a block diagram of the pixel matrix and related control circuitry corresponding to the liquid crystal display device according to the present invention.

FIG. 2 is a schematic diagram illustrating one embodiment of a system according to the present invention for writing a video frame.

FIG. 3 is a schematic diagram illustrating another embodiment of a system according to the present invention for writing a video frame.

FIG. 4 is a schematic diagram illustrating yet another embodiment of a system according to the present invention for writing a video frame.

FIG. 5 is a schematic diagram illustrating still another embodiment of a system according to the present invention for writing a video frame.

FIG. 6 is a functional flow diagram illustrating one method of writing a video frame according to the present invention.

FIG. 7 is a functional flow diagram illustrating another method of writing a video frame according to the present invention.

FIG. 8 is a functional flow diagram illustrating yet another method of writing a video frame according to the present invention.

### DETAILED DESCRIPTION OF THE PREFERRED EMBODIMENTS

The present invention is directed to liquid crystal display devices having circuits for fast writing to pixels a frame of video information. The pixels or a subgroup of them are first precharged to a selected preferred voltage then the final pixel values are written to each pixel. The selected preferred voltage is preferably a grayshade near 128 on a scale where black is grayshade 0 and white is grayshade 255. (The 16.7 million color space is defined as 256 grayshades of red, 256 grayshades of green and 256 of blue. The 16.7 million figure is the cube of 256).

Referring now to the drawings, the details of preferred embodiments of the invention are schematically illustrated. Like elements in the drawings will be represented by like numbers, and similar elements will be represented by like numbers with a different lower case letter suffix.

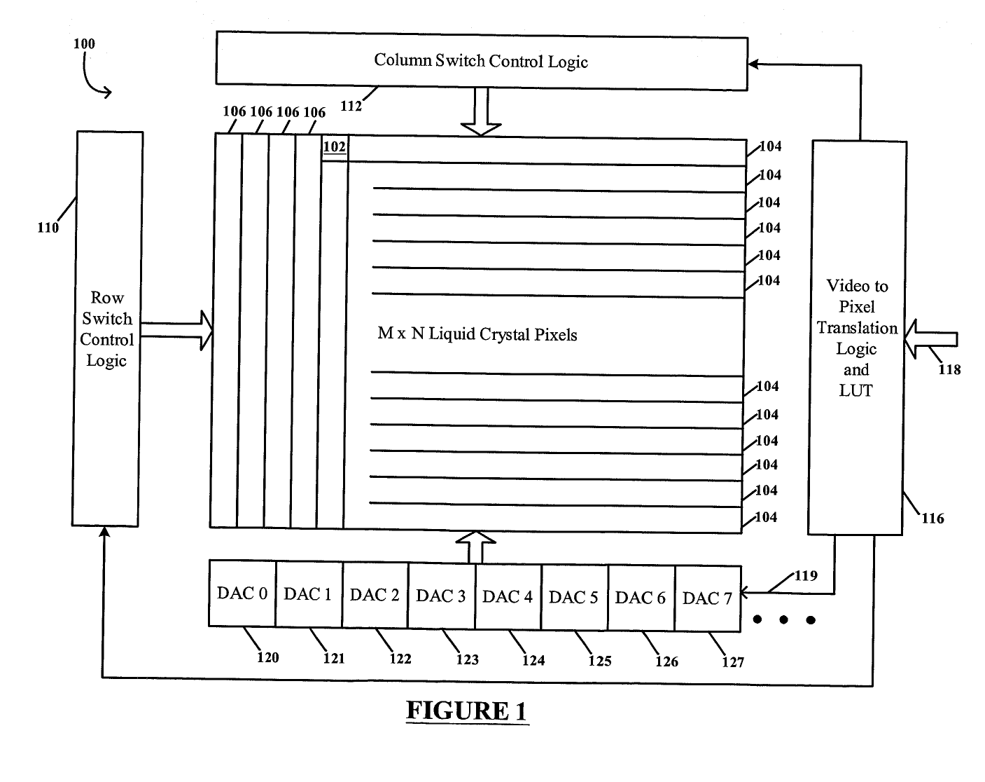

FIG. 1 illustrates a schematic block diagram of a liquid crystal display system in accordance with the embodiments of the present invention. A high-level block diagram of a system for writing voltage values to pixels of a liquid crystal display (LCD) is generally represented by the numeral 100. The voltage values being written to the pixels are representative of a frame of video data. The voltage values control the “twist” of the liquid crystal material at each pixel so that when a light is flashed on or through the LCD, the light polarization and ultimately the intensity of the light is controlled by the “twist” of the liquid crystal material in each pixel in the LCD.

For illustrative purposes, the LCD 100 depicted in FIG. 1 comprises a matrix of pixels 102 having M rows 104 and N columns 106. The combination of row control logic 110 and column control logic 112 are used to select each of the pixels for writing thereto in the LCD 100, as more fully described hereinbelow. Video to pixel translation logic (hereinafter translation logic) 116 performs the necessary calculations and steps to translate a video frame image 118 into discrete digital values 119 which are sent to digital-to-analog converters (DACS) 120, 121, 122, 123, 124, 125, 126 and 127, and the pixel location addresses thereof are sent to the row and column control logic 110 and 112. It is contemplated and within the scope of the present invention that an LCD having any number of rows and columns may benefit from the present invention. In addition, any number of DACs may be used according to embodiments of the present invention.

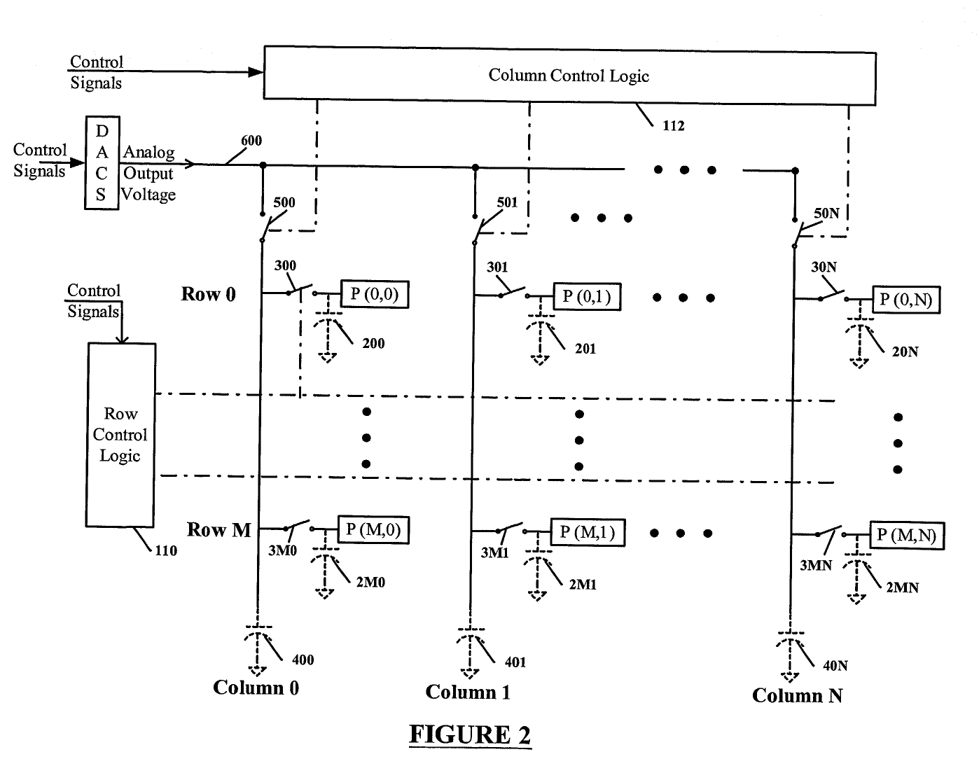

Referring now to FIG. 2, a schematic diagram of the pixel capacitors of the liquid crystal display system of FIG. 1 is illustrated. The M×N matrix comprises pixels P(0,0) through P(M,N), pixel capacitors 200 through 2MN, pixel row switches 300 through 3MN, pixel column capacitors 400 through 40N, and pixel column switches 500 through 50N. The pixel row switches 200 though 2MN connect the pixel capacitors P(0,0) through P(M,N) to the Columns 0 through N. The pixel column switches 500 through 5ON connect the column capacitors 400 through 40N, respectively, to the output voltage 600.

An LCD operates by applying certain voltage values to each pixel of the LCD. A certain voltage at a pixel causes liquid crystals at that pixel to change their “twist” orientation so that light passing through the LCD or being reflected is thereby affected. The translation logic 116 uses the received video frame information 118 to create appropriate voltage values which are representative of that portion of the video frame at each one of the pixel locations. In addition, the translation logic 116 associates an x-y coordinate (row-column) location for each of these pixel voltage values.

The DACs 120-127 receive digital representations of the voltage values from the translation logic 116 and convert these digital representations to analog voltage values which must then be applied to each corresponding pixel location. Each of the pixels P(0,0) through P(M,N) has a capacitance associated therewith, and each of the columns 0 through N has a capacitance associated therewith. The capacitance of each pixel may not all be the same, nor may the capacitance of each column be the same. The column capacitance is greater than the pixel capacitance. An analog voltage value must charge the respective column and pixel capacitances to which it is applied. The output of the DAC is connected to the column and thereby fully charges the capacitance to a desired analog voltage, then the pixel is connected to the column and the pixel capacitance is charged from the voltage on the column. Since the column capacitance is greater than the pixel capacitance, the voltage on the pixel will be substantially the same as the voltage on the column.

The liquid crystal material also has a finite time constant for orientation by the applied voltage. The voltage applied to each pixel must also be alternately reversed in polarity so that a direct current charge does not develop on the liquid crystal material. All of these factors increase the write time of a pixel necessary for the liquid crystals of the pixels to settle into the desired light modification positions. It is desirable and necessary that the pixel capacitance be charged as quickly as possible so as to maximize the available settling time of the liquid crystal material at each pixel position. It is also necessary that the pixel capacitances be charged as close to the target capacitance as possible.

All LCDs charge a column to a certain voltage then select a pixel row so that the intersection thereof is the desired pixel to be charged. For example, columns 0-7 are charged from the DACs 120-127, respectively, when the column switches 500-507 are closed. Pixels P(0,0) through P(0,7) are charged from the columns 0-7, respectively, when the row switches 300-307 are closed. A plurality of DACs may be used to simultaneously charge a like number of columns, then a like number of switches in a row may be used to charge a like number of pixels from the charged columns. The column control logic 112 and row control logic 110 control operation of the column switches 500-50N and row switches 300-3MN, respectively.

In the embodiment of the invention shown in FIG. 2, the column control logic circuit 112 sends a control signal to the column switches 500 through 5ON to couple the columns 0 through N respectively to the analog output voltage 600, which is driven to a fixed voltage prior to the writing of each row. The analog output voltage 600 is driven by the DACs from control signals received from the translation logic circuit 118. Preferably, the fixed voltage is a mid gray voltage value. In this way, the maximum voltage excursion in charging a column to any grayshade is minimized. Thus, the column capacitors 400 through 40N are precharged to the mid gray voltage or some other mid range fixed voltage prior to the writing of each row.

In this embodiment, each row is written by having the row control logic circuit 118 send a control signal to the desired row, for example Row 0. All of the row switches in Row 0, namely switches 300 through 30N, are thereby closed. Next, each of the pixels in Row 0, namely P(0,0) through P(0,N) are individually and sequentially coupled to the analog output voltage 600. During the writing of each row, in this case Row 0, the analog output voltage is driven to the video voltage(s) desired to be stored on each pixel capacitor (200-20N). After Row 0 is written, but before Row 1 is written, the column capacitors 400 through 40N are precharged to the mid gray voltage. This step is repeated between the writing of each row until all of the rows have been written and the frame is complete.

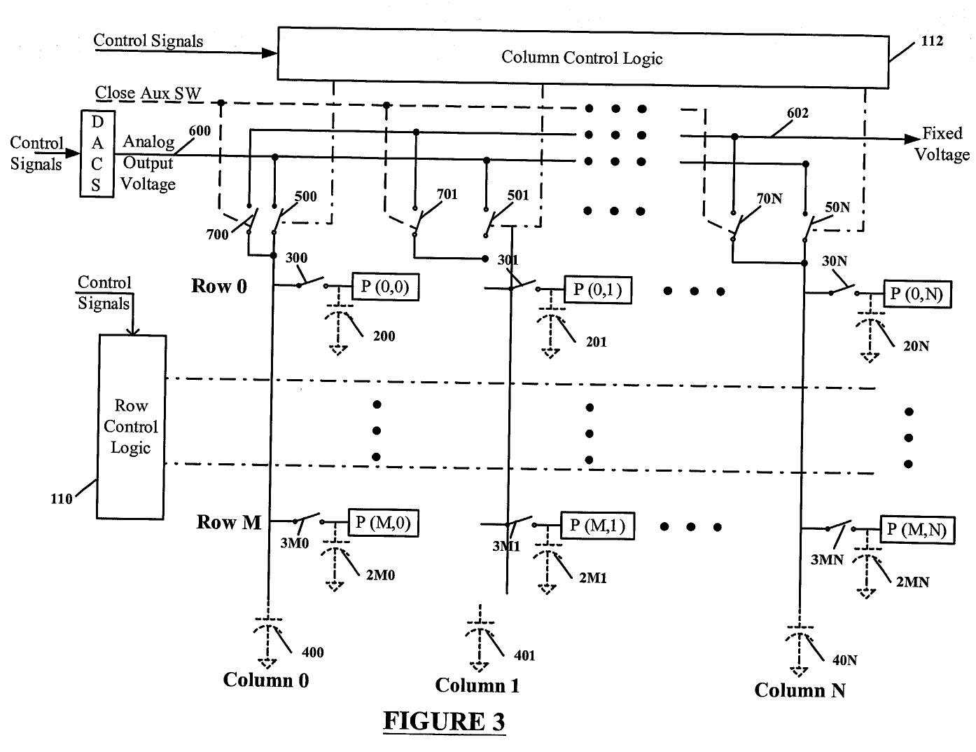

FIG. 3 illustrates a schematic diagram of another embodiment of the liquid crystal display system according to the present invention. In this embodiment of the present invention, the LCD includes a plurality of auxiliary or secondary column switches 700 through 70N, which couple the columns 0-N to a fixed voltage 602 prior to writing each of the rows. The fixed voltage 602 is supplied from a voltage source (not shown) independent of the DACS and is preferably driven to the selected preferred voltage. The selected preferred voltage is found through an understanding of the L.C. switching performance and the driving performance. The secondary column switches 700 are activated by control signals, which may be sent either directly from the translation logic circuit 118 or through the column control logic circuit 112. Thus, in this embodiment of the present invention, the column capacitors 400 through 40N are also precharged to the selected preferred voltage or some other fixed voltage prior to the writing of each row. Furthermore, each row is written as described above with respect to the previous embodiment.

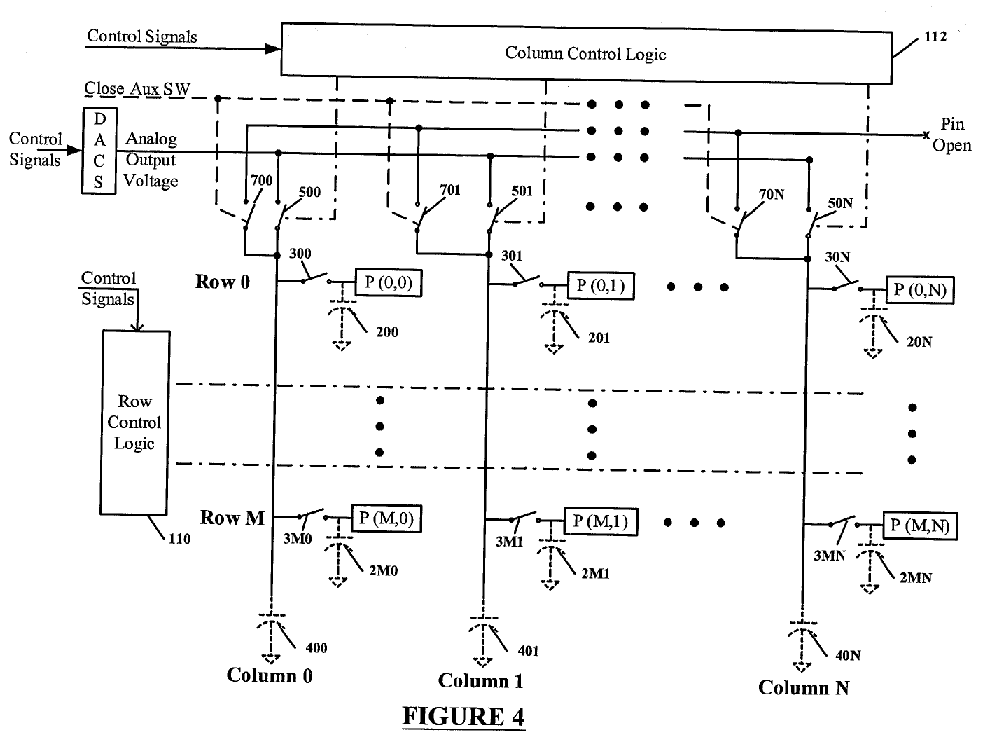

FIG. 4 illustrates a schematic diagram of yet another embodiment of the liquid crystal display system according to the present invention. In this embodiment, the secondary column switches 700-70N are instructed to couple the plurality of columns 0-N to each other to thereby equalize the one or more voltages stored on the columns prior to the writing of each row. Control signals may be sent to the secondary column switches 700-70N in this embodiment by the translation logic circuit 118 or through the column control logic circuit 112.

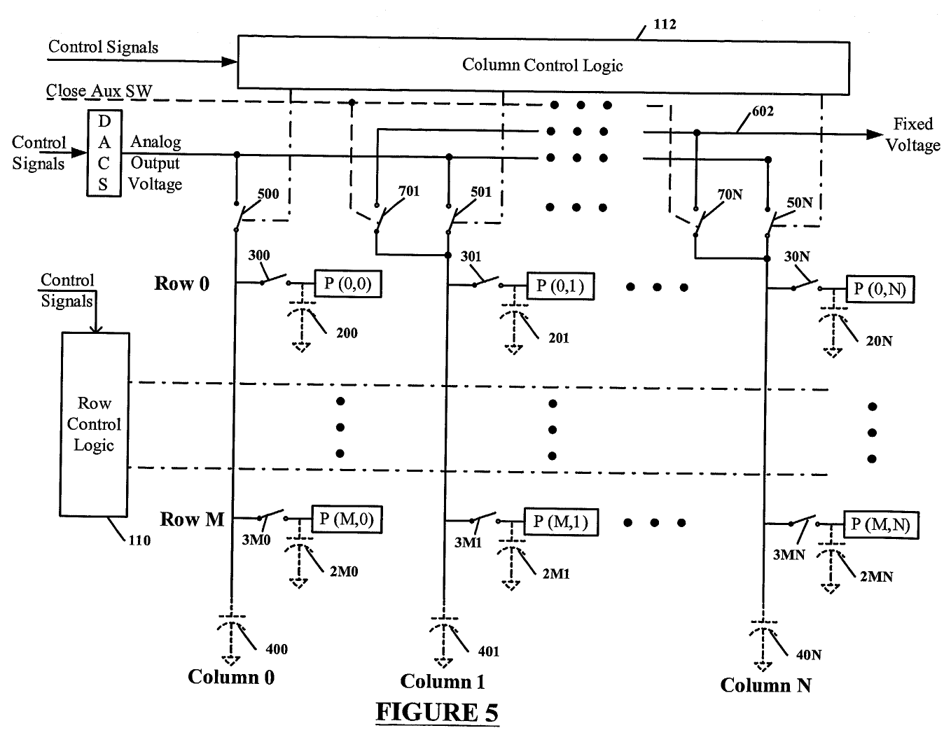

The preferred embodiment of the present invention is illustrated in FIG. 5. In this embodiment, the column control logic circuit 112 sends a control signal to a primary column switch, for example switch 500, to couple its associated column (0) to a desired video voltage. The translation logic circuit 116 (or alternatively the column control logic circuit 112) sends another control signal (Close Aux SW) to the secondary column switch in the successive column, in this case switch 701, so as to couple the successive column (1) to the fixed voltage. This arrangement thereby enables column 1 to be charged to the fixed voltage while column 0 is being charged to the desired video voltage.

In the embodiment of FIG. 5, the column control logic circuit 112 is further adapted to send a control signal to the primary column switch 501 to couple column 1 to a desired video voltage and the translation logic circuit 116 (or alternatively the column control logic circuit 112) is adapted to send a control signal to the secondary column switch (702) corresponding to the next successive column (2) to couple the next successive column to the fixed voltage. This enables the successive column to be charged to its desired video voltage as the next successive column is being charged to the fixed voltage. This sequence of charging one column capacitor to a desired video voltage while the successive column capacitor is being charged to a fixed voltage is repeated until all of the pixels in a given row have been written. It is then repeated for each successive row until all of the rows in the matrix have been written.

In one variant of the embodiment illustrated in FIG. 5, the logic circuitry is adapted to send a control signal to the secondary column switches in a group of columns, i.e., the successive two or more columns, to couple the group of columns to the fixed voltage while the preceding column is being charged to the desired video voltage.

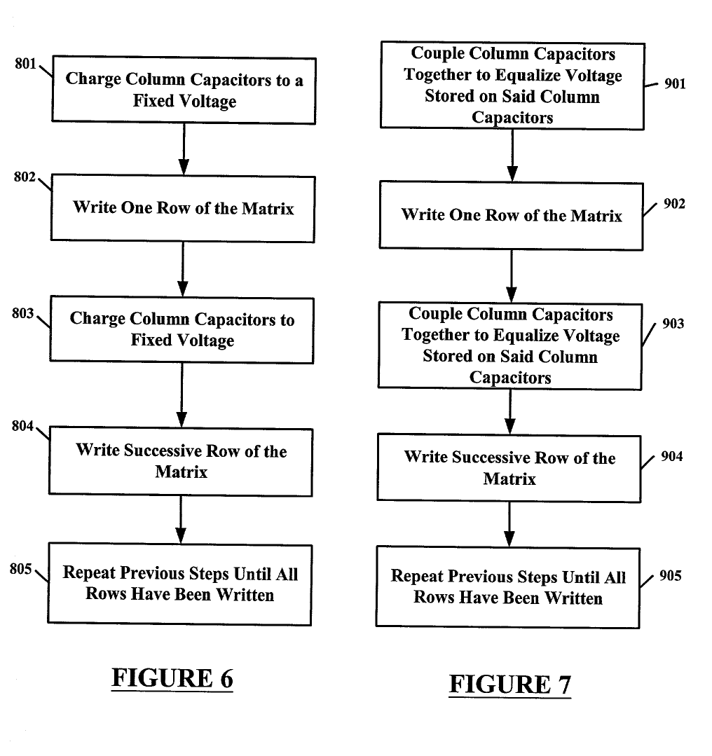

FIG. 6 illustrates one method of writing a video frame according to the present invention. First, the column capacitors are charged to a fixed voltage, preferably a mid gray voltage. This step is illustrated in block 801. The column capacitors can be charged to a fixed voltage either by coupling them to an analog voltage output by the DACs, which is driven to a preferred fixed voltage under the command of the logic circuitry, or by coupling them to a voltage supply driven to a preferred fixed voltage. After the column capacitors are charged to the fixed voltage a row is written, as illustrated in block 802. A row is written, as described above, by coupling all of the pixel capacitors to the columns, and sequentially coupling the columns to the video voltage(s) desired to be stored on each of the pixel capacitors in the row. After a row has been written, the column capacitors are charged again to the fixed voltage, as illustrated in block 803. Next, the successive row is written as described above, as illustrated in block 804. These steps are repeated until all of the rows in the matrix have been written, as illustrated in block 805.

In an alternate embodiment, the method is carried out by coupling the column capacitors together between the writing of successive rows, so that the voltage stored on the column capacitors during the writing of the previous row is equalized to an average value prior to writing the next row. This modified method is illustrated in blocks 901-905 of FIG. 7.

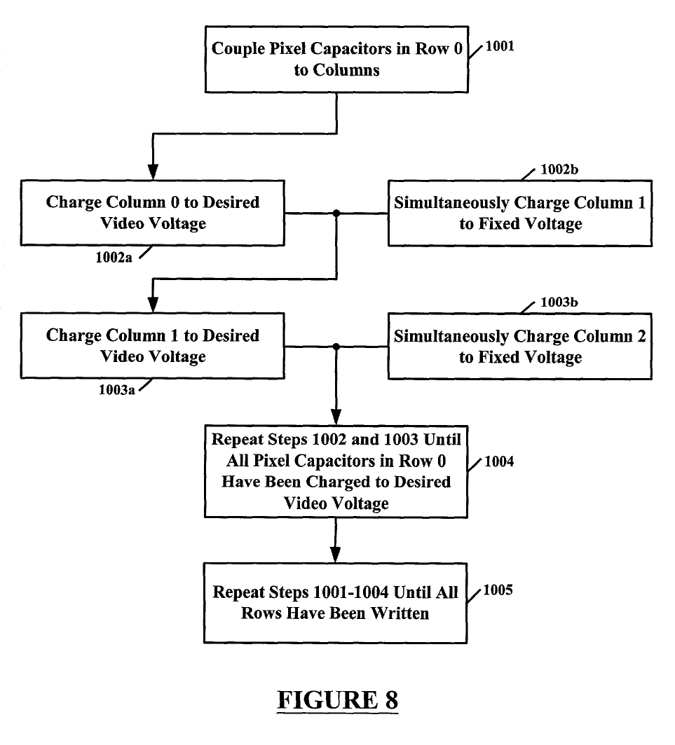

In still another embodiment of the present invention, the method is carried out by first coupling the pixel capacitors in row 0 to columns 0-N. This step is illustrated in block 1001 in FIG. 8. In the next step, the column capacitor 400 in column 0 is charged to a desired video voltage while the successive column capacitor 401 in column 1 is charged to a fixed voltage. These steps are illustrated in blocks 1002a and 1002b in FIG. 8. In the next step, column capacitor 401 in column 1 is charged to a desired video voltage while the next successive column capacitor 402 in column 2 is charged to the fixed voltage. This step is illustrated in blocks 1003a and 1003b. The sequence of charging one column capacitor to a desired video voltage while the successive column capacitor is being charged to a fixed voltage is repeated until all of the pixels in a given row have been written. This is illustrated in block 1004. The sequence is then repeated for each successive row until all of the rows in the matrix have been written. This is illustrated in block 1005.

A variant of the latter method is performed by charging a group of successive column capacitors, e.g., charging column capacitors 401 and 402 or 401, 402 and 403 to a fixed voltage while charging column capacitor 400 to the desired video voltage. As those of ordinary skill in the art will appreciate, any number of column capacitors could be included in the block of successive column capacitors being charged to the fixed voltage while the preceding column capacitor in a given row is being charged to a desired video voltage.

It is contemplated and within the scope of the embodiments of the present invention that the LCD and LCD system may be partially or entirely fabricated on a semiconductor integrated circuit.

While the present invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

What is claimed is:

1. A system for writing a video frame row by row in a liquid crystal display (LCD) having a matrix of liquid crystal pixels arranged in a plurality of columns and a plurality of rows, said system comprising:
a plurality of column switches adapted for coupling the plurality of columns of said LCD to an output voltage;
a plurality of row switches adapted for selectively coupling the plurality of columns to the pixels of said LCD; and
logic circuitry coupled to the plurality of column switches and the plurality of row switches, said logic circuitry adapted to send a control signal to the plurality of column switches to couple said columns to a fixed voltage prior to the writing of each row, thereby charging said columns prior to the writing of each row.

2. A system for writing a video frame in a liquid crystal display (LCD) according to claim 1, wherein the logic circuitry includes a column control logic circuit coupled to the plurality of column switches and a row control logic circuit coupled to the plurality of row switches.

3. A system for writing a video frame in a liquid crystal display (LCD) according to claim 1, wherein the logic circuitry is coupled to at least one digital-to-analog converter (DAC), which outputs the output voltage, and said logic circuitry commands said at least one DAC to output a desired video voltage.

4. A system for writing a video frame in a liquid crystal display (LCD) according to claim 3, wherein the logic circuitry commands said at least one DAC to output the fixed voltage.

5. A system for writing a video frame row by row in a liquid crystal display (LCD) having a matrix of liquid crystal pixels arranged in a plurality of columns and a plurality of rows, said system comprising:
a plurality of column switches adapted for coupling the plurality of columns of said LCD to an output voltage;
a plurality of secondary column switches adapted for coupling at least one of the plurality of columns to a fixed voltage;
a plurality of row switches adapted for selectively coupling the plurality of columns to the pixels of said LCD; and
logic circuitry coupled to the plurality of primary and secondary column switches and the plurality of row switches, said logic circuitry adapted to send a control signal to the at least one secondary column switch to couple at least one of the plurality of columns to the fixed voltage thereby charging said at least one column prior to the writing of each row.

6. A system for writing a video frame row by row in a liquid crystal display (LCD) having a matrix of liquid crystal pixels arranged in a plurality of columns and a plurality of rows, said system comprising:
a plurality of column switches adapted for coupling the plurality of columns of said LCD to an output voltage;
a plurality of row switches adapted for selectively coupling the plurality of columns to the pixels of said LCD; and
logic circuitry coupled to the plurality of column switches and the plurality of row switches, said logic circuitry adapted to send a control signal to the plurality of column switches to couple said columns to each other to thereby equalize one or more voltages stored on said columns prior to the writing of each row.

7. A system for writing a video frame in a liquid crystal display (LCD) according to claim 6, wherein the logic circuitry includes a column control logic circuit coupled to the plurality of column switches and a row control logic circuit coupled to the plurality of row switches.

8. A system for writing a video frame in a liquid crystal display (LCD) having a matrix of liquid crystal pixels arranged in a plurality of columns and a plurality of rows, said system comprising:
a plurality of primary column switches adapted for coupling the plurality of columns of said LCD to an output voltage;
a plurality of secondary column switches adapted for coupling at least one of the plurality of columns of said LCD to a fixed voltage;
a plurality of row switches adapted for selectively coupling the plurality of columns to the pixels of said LCD; and
logic circuitry coupled to the plurality of primary and secondary column switches and the plurality of row switches, said logic circuitry adapted to send a control signal to one primary column switch to couple its associated column to a desired video voltage and another control signal to a secondary column switch in a successive column so as to couple the successive column to the fixed voltage to thereby charge said successive column while the preceding column is being charged to the desired video voltage.

9. A system for writing a video frame in a liquid crystal display (LCD) according to claim 8, wherein the logic circuitry includes a column control logic circuit coupled to the plurality of primary and secondary column switches and a row control logic circuit coupled to the plurality of row switches.

10. A system for writing a video frame in a liquid crystal display (LCD) according to claim 8, wherein the logic circuitry is adapted to send a control signal to the secondary column switches in the successive two or more columns to couple said two or more successive columns to the fixed voltage while the preceding column is being charged to the desired video voltage.

11. A system for writing a video frame in a liquid crystal display (LCD) according to claim 8, wherein the logic circuitry is adapted to send a control signal to the primary column switch to couple the successive column to a desired video voltage and send a control signal to a secondary column switch corresponding to the next successive column to couple said next successive column to the fixed voltage, so that as the successive column is being charged to its desired video voltage the next successive column is being charged to the fixed voltage.

12. A system for writing a video frame in a liquid crystal display (LCD) according to claim 8, wherein the logic circuitry is adapted to send control signals to the primary and secondary column switches and the row switches so that the sequence of charging one column capacitor to a desired video voltage while the successive column capacitor is being charged to a fixed voltage is repeated until all of the pixels in a given row have been written, and said sequence is again repeated for each successive row until all of the rows in the matrix have been written.

13. A system for writing a video frame in a liquid crystal display (LCD) according to claim 8, wherein the logic circuitry is coupled to at least one digital-to-analog converter (DAC), which outputs the output voltage, and said logic circuitry commands said at least one DAC to output the desired video voltage.

14. A system for writing a video frame in a liquid crystal display (LCD) according to claim 8, wherein the logic circuitry is coupled to at least one digital-to-analog converter (DAC), which outputs the output voltage, and said logic circuitry commands said at least one DAC to output the fixed voltage.

15. A system for writing a video frame in a liquid crystal display (LCD) according to claim 8, wherein the fixed voltage is generated by a voltage supply independent from the voltage supply that generates the desired video voltage.

16. A method for writing a video frame row by row in a liquid crystal display (LCD) having a matrix of liquid crystal pixels arranged in a plurality of columns and a plurality of rows, wherein each column has an associated capacitor and each pixel has an associated capacitor, said method comprising the step of charging the column capacitors to a fixed voltage prior to writing each row.

17. A method for writing a video frame in a liquid crystal display (LCD) according to claim 16, wherein the column capacitors are charged to a fixed voltage by coupling them to an analog voltage driven to a selected preferred voltage under the command of a logic circuit.

18. A method for writing a video frame in a liquid crystal display (LCD) according to claim 16, wherein the column capacitors are charged to a fixed voltage by coupling them to a voltage supply driven to a selected preferred voltage.

19. A method for writing a video frame row by row in a liquid crystal display (LCD) having a matrix of liquid crystal pixels arranged in a plurality of columns and a plurality of rows, wherein each column has an associated capacitor and each pixel has an associated capacitor, said method comprising the step of coupling the column capacitors together prior to writing each row, so that the voltage stored on the column capacitors is equalized to an average value prior to writing each row.

20. A method for writing a video frame row by row in a liquid crystal display (LCD) having a matrix of liquid crystal pixels arranged in a plurality of columns and a plurality of rows, wherein each column has an associated capacitor and each pixel has an associated capacitor, said method comprising the step of charging a column capacitor to a desired video voltage while charging a successive column capacitor to a fixed voltage during the writing of each row.

21. A method for writing a video frame in a liquid crystal display (LCD) according to claim 20, wherein the step is performed by charging two or more successive column capacitors to a fixed voltage while charging the column capacitor to the desired video voltage.

22. A method for writing a video frame in a liquid crystal display (LCD) according to claim 20, wherein after the successive column capacitor is charged to the fixed voltage it is charged to a desired video voltage and at the same time the next successive column capacitor is charged to the fixed voltage.

23. A method for writing a video frame in a liquid crystal display (LCD) according to claim 20, wherein the sequence of charging one column capacitor to a desired video voltage while the successive column capacitor is being charged to a fixed voltage is repeated until all of the pixels in a given row have been written, and said sequence is again repeated for each successive row until all of the rows in the matrix have been written.

24. A method for writing a video frame in a liquid crystal display (LCD) according to claim 20, wherein the column capacitor is charged to the fixed voltage by coupling it to an analog voltage driven to a selected preferred voltage under the command of a logic circuit.

25. A method for writing a video frame in a liquid crystal display (LCD) according to claim 20, wherein the column capacitor is charged to the fixed voltage by coupling it to a voltage supply driven to a selected preferred voltage.
